(19) United States
(12) Patent Application Publication
(10) Pub. No.: US 2022/0203261 A1
(43) Pub. Date: Jun. 30, 2022

(54) CONTINUOUS SUPERCRITICAL EXTRACTION SYSTEM AND METHODS

(71) Applicant: GREEN MILL SUPERCRITICAL, INC., Pittsburgh, PA (US)

(72) Inventor: Jeremy DIEHL, Pittsburgh, PA (US)

(73) Assignee: GREEN MILL SUPERCRITICAL, INC., Pittsburgh, PA (US)

(21) Appl. No.: 17/602,486

(22) PCT Filed: Apr. 8, 2020
(86) PCT No.: PCT/US2020/027330

§ 371 Date: Oct. 8, 2021

Related U.S. Application Data
(60) Provisional application No. 62/830,923, filed on Apr. 8, 2019.

(51) Int. Cl. B01D 11/02

(52) U.S. Cl. CPC B01D 11/0203; B01D 11/0292; B01D 11/028

(57) ABSTRACT

Methods and apparatus for the improved extraction of compounds from a charge material are disclosed. The improved extraction is achieved at least a bypass line that permits the transfer of sCO₂ and/or CO₂ to an extraction vessel and a hopper that achieves greater productivity in loading the extraction vessel.

### CROSS-REFERENCE TO RELATED APPLICATIONS

This application claims priority to U.S. Provisional Application Ser. No. 62/830,923 filed on Apr. 8, 2019, the content of which is hereby incorporated by reference in its entirety.

### FIELD

This disclosure relates to methods and systems for extraction. More particularly this disclosure relates to continuous supercritical extraction methods and systems.

### BACKGROUND

Recently, there has been increased interest by consumers in the extraction of various organic compounds from plants for human use and consumption. Conventionally, extraction has been performed using various organic solvents such as perchloroethylene, ethyl alcohol, butane, methylene chloride, and hexane which are selected to take up the desired organic compounds. While effective, these compounds have drawbacks, such as leaving trace amounts of the solvent in the extracted product.

Supercritical carbon dioxide (referred to herein as “sCO₂” and “supercritical CO₂”) is a fluid state of carbon dioxide that occurs when CO₂ is maintained above its critical temperature and critical pressure, known as the “critical point.” This critical point in the phase diagram of CO₂ is important because it is here that the phase boundaries between liquid and gas vanish, and the CO₂ behaves as a supercritical fluid. Supercritical fluids such as sCO₂ are unique because they exhibit some properties which are like a gas, and other properties which are like a liquid. For example, sCO₂ will effuse through small openings and spaces in solids the same way that gasses do. As another example, sCO₂ will also dissolve materials in the same way that liquids do.

Supercritical CO₂ also has its own unique properties that are important to the extraction industry. CO₂ is generally inert and does not react with the compounds that it is used to extract, which is important in maintaining the safety, quality, flavors, and scents of organic compounds which are used by humans. CO₂ is also easy to manage during extraction because after it has finished forming a solution with the extracted compounds, it can be depressurized below the critical point which causes the sCO₂ to change to gas and the extracted compounds to “drop out” of solution for easy collection. The now gaseous CO₂ is mostly clean and can be collected and easily recycled before being pumped again through new material to extract. CO₂ is also affordable and non-toxic, which cannot be said for other prior art solvents.

The most important advantage of sCO₂ in extraction is that its affinity for dissolved compounds, especially oils and other valuable compounds which are found in organic plant matter, can be “tuned” by precisely controlling the temperature and pressure within the supercritical phase. This allows the sCO₂ to selectively act as a solvent for specific materials. However, prior art extraction techniques and devices that have employed sCO₂ have often failed to take advantage of this important property. These prior art techniques result in extracted product that is inconsistent and of poor quality. Prior art extraction devices are also inefficient in the amount of extract that is obtained from the plant matter and other raw material from which extracts are removed. Previously submitted U.S. Patent Application Ser. No. 62/688,818 entitled “Supercritical Carbon Dioxide Extraction” filed on Jun. 22, 2018, which is hereby incorporated by reference in its entirety, discloses improvements in the extraction process to achieve consistent, high quality extraction. Improvements in the extraction process were also proposed to achieve consistent, high quality extraction in World Intellectual Property Organization Application No. PCT/US2019/038722 entitled “Improvements in supercritical carbon dioxide extraction” which was filed on Jun. 24, 2019 and which was published on Dec. 26, 2019 as WO 2019/246619 and is incorporated by reference herein in its entirety.

Along with the above disclosures, further improvements in sCO₂ extraction can be achieved. One problem with conventional sCO₂ extraction technology is the lengthy downtime between extraction operations that is needed to depressurize the apparatus, remove spent charge material from the apparatus, add fresh charge material to the apparatus, and pressurize the apparatus for the next production run. Previous efforts have sought to lessen the impact of this downtime in two ways. In the first approach, extraction apparatus components such as the extraction vessel are made larger to accommodate a larger volume of charge. This approach achieves greater charge material capacity and increased product output, but also causes lowered extraction efficiency as sCO₂ quickly becomes “saturated” with extracted oils and other compounds. Large extraction vessels also lead to the sCO₂ “channeling,” or forming pathways of least resistance through or around the charge material, which wastes energy but does not result in additional extraction. The large sCO₂ volumes also lead to significant energy waste in the form of pumping losses as sCO₂ is pumped through spent charge material that has already been extracted.

The second approach for lessening the impact of downtime is to duplicate components such as the extraction vessel. In a typical configuration, three large extraction vessels are provided, but only two extraction vessels are pressurized and operated using sCO₂ at one time, while the remaining extraction vessel is idle and prepared for the next extraction operation. This approach ensures that extraction operations continue even during replenishment of fresh charge material. However, this approach has the drawback that extraction vessels are duplicated, as are the piping, valves, sensors, and controls associated with each extraction vessel. The result is an extraction apparatus that is costly and complex.

There is a continuing need for efficient, continuous extraction of organic compounds from plants for human use and consumption.

### SUMMARY

The disclosure provides various embodiments directed to extracting compounds from a charge material. This summary is submitted with the understanding that it should not be used to interpret or limit the scope or meaning of the claims.

In one embodiment, there is a method of continuous extraction of compounds from a charge material, comprising loading a charge material from a hopper into an extraction vessel through a loading port; closing the loading port; pressurizing the extraction vessel with sCO₂ and/or CO₂ from a bypass line; extracting compounds from the charge material; and depressurizing the extraction vessel by sending sCO₂ and/or CO₂ through the bypass line.

In another embodiment, the extraction vessel has an internal volume of less than about 2.0 liters.

In another embodiment, extraction vessel has an internal volume of less than about 1.0 liter.

In another embodiment, the compounds extracted from the charge material are selected from the group consisting of cannabinoids, tetrahydrocannabinol (THC), cannabinoid isomers, cannabinoid stereoisomers, tetrahydrocannabinolic acid (THCA), cannabidiol (CBD), cannabidiolic acid (CBDA), cannabinol, (CBN), cannabigerol (CBG), cannabichromene (CPC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannebielsoin (CBE), cannabicitran (CBT), and combinations and derivatives thereof.

In another embodiment, the charge material is cannabis.

In another embodiment, the steps of loading the charge materials, pressurizing the extraction vessel, extracting the compounds from the charge materials, and depressurizing the extraction vessel are performed in sequential order.

In one embodiment, there is an apparatus for continuous extraction of compounds from a charge material, comprising a hopper for loading a charge material from the hopper into an extraction vessel through a loading port, wherein the loading port can be closed; a bypass line for pressurizing the extraction vessel with sCO₂ and/or CO_{2;} wherein during operation the extraction vessel extracts compounds from the charge material; and wherein during operation the extraction vessel is depressurized by sending sCO₂ and/or CO₂ through the bypass line.

In another embodiment, the extraction vessel has an internal volume of less than about 2.0 liters.

In another embodiment, the extraction vessel has an internal volume of less than about 1.0 liter.

In another embodiment, the compounds that the apparatus extracts from the charge material are selected from the group consisting of cannabinoids, tetrahydrocannabinol (THC), cannabinoid isomers, cannabinoid stereoisomers, tetrahydrocannabinolic acid (THCA), cannabidiol (CBD), cannabidiolic acid (CBDA), cannabinol, (CBN), cannabigerol (CBG), cannabichromene (CPC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannebielsoin (CBE), cannabicitran (CBT), and combinations and derivatives thereof.

In another embodiment, the charge material is cannabis.

In another embodiment, the apparatus loads the charge materials, pressurizes the extraction vessel, extracts the compounds from the charge materials, and depressurizes the extraction vessel in sequential order.

### DRAWINGS

Aspects, features, benefits, and advantages of the embodiment described herein will be apparent with regard to the following description, appended claims, and accompanying drawings. In the drawings:

FIG. 1 is an illustration of an extraction method in accordance with an embodiment.

FIG. 2 is an illustration of an extraction apparatus in accordance with an embodiment.

FIG. 3 is an illustration of an extraction apparatus and associated process steps in accordance with an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

### The Compounds

The extraction apparatus of the disclosure can be used to extract any desired compounds from a “charge.” As used herein, a “charge” means a quantity, sample, or other mass of one or more of organic, plant, or fungus material. The charge can be or include any desirable plant or fungal species, and these are used to extract various useful compounds. Compounds include those from the plants and trees Cassia, Cinnamon, Sassafras, Camphor, Cedar, Rosewood, Sandalwood, Agarwood, Galangal, Ginger, Basil, Bay Leaf, Buchu, Cannabis, Cinnamon, Sage, Eucalyptus, Guava, Lemon grass, Midaleuca, Oregano, Patchouli, Peppermint, Pine, Rosemary, Spearmint, Tea tree, Thyme, Tsuga, Wintergreen, Benzoin, Copaiba, Frankincense, Myrrh, Chamomile, Clary sage, Clove, Scented geranium, Hops, Hyssop, Jasmine, Lavender, Manuka, Marjoram, Orange, Rose, Ylang-ylang, Bergamot, Grapefruit, Lemon, Lime, Orange, Mango, Tangerine, Valerian , Berries including Allspice and Juniper; Seeds including Anise, Buchu, Celery, Cumin, Nutmeg oil; truffles; or the like. In addition or in the alternative to the specific kinds of plants and trees described above, the charge may also be formed from the wood, rhizomes, resins, peels, flowers, roots, stems, bark, leaves, or any other parts of organic materials, plant materials, or fungus materials, or combinations of any of the above.

In some embodiments, the charge is formed from plant materials. Examples of plant materials that are used for the charge are not limited, and include Cannabis sativa, Cannabis indica, and Cannabis ruderalis (collectively referred to as “cannabis” throughout the disclosure), including varieties that are cultivated for medical, industrial, textile, fuel, paper, chemical, food, and recreational purposes, among other uses. When the charge is cannabis, it is any part of the cannabis plant, including the stems, leaves, seeds, flowers, buds, roots, or combinations thereof. In some embodiments, the plant charge of cannabis is used for the extraction of various useful compounds, including cannabinoids, tetrahydrocannabinol (THC), cannabinoid isomers, cannabinoid stereoisomers, tetrahydrocannabinolic acid (THCA), cannabidiol (CBD), cannabidiolic acid (CBDA), cannabinol, (CBN), cannabigerol (CBG), cannabichromene (CPC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannebielsoin (CBE), cannabicitran (CBT), and combinations and derivatives of the above.

While the above plants and compounds are described, the extraction apparatus and methods of the disclosure and its use of CO₂ is not limited in application and can be used to extract any useful compound from any plant or fungal charge that is placed within it. In particular, oils, resins, terpenes, acids, bases, aqueous solutions, and other compounds are all contemplated for extraction by the disclosed extraction apparatus and methods.

### Continuous Extraction

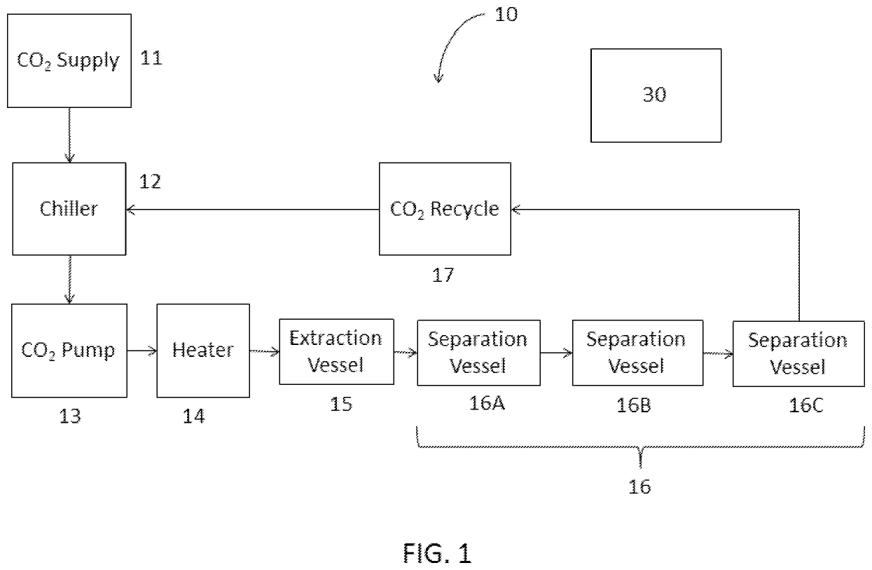

The disclosure includes a novel extraction process that improves extraction efficiency. Turning to FIG. 1, a flowchart of the extraction apparatus and its attendant process steps for extraction 10 is described. In Step 11, a supply of CO₂ and any other additives is provided, typically from a pressurized tank or sublimating from an enclosed block. The pressure within the tanks is typically about 500 psia to about 900 psia.

In Step 12, the supply of CO₂ is piped to a chiller, which removes excess heat and brings the CO₂ to a temperature that is sufficiently cool such that when subsequently pumped, any heat of compression causes it to rise to the supercritical portion of the phase. For CO₂, this means a temperature of about −5° C. to about 5° C. Next, in Step 13, a pump compresses the CO₂ so that it passes the critical point and becomes supercritical. The CO₂ may be pressurized up to about 7,500 psia to about 20,000 psia. In some embodiments, the pressure of the CO₂ may be about 400 psia, about 1,000 psia, about 1,500 psia, about 2,000 psia, about 2,500 psia, about 3,000 psia, about 4,000 psia, about 4,500 psia, about 5,000 psia, about 5,500 psia, about 6,000 psia, about 6,500 psia, about 7,000 psia, about 7,500 psia, about 8,000 psia, about 8,500 psia, about 9,000 psia, about 9,500 psia, about 10,000 psia, about 10,500 psia, about 11,000 psia, about 11,500 psia, about 12,000 psia, about 12,500 psia, about 13,000 psia, about 13,500 psia, about 14,000 psia, about 14,500 psia, about 15,000 psia, about 15,500 psia, about 16,000 psia, about 16,500 psia, about 17,000 psia, about 17,500 psia, about 18,000 psia, about 18,500 psia, about 19,000 psia, about 19,500 psia, about 20,000 psia, or any range between any two of the above listed pressure values. In Step 13, the CO₂ may be heated to about 1° C. to about 250° C. and maintained at a pressure set between about 400 psi to about 20,000 psi. The temperature of the CO₂ may be about 50° C., about 100° C., about 150° C., about 200° C., about 250° C., about 300° C., about 350° C., about 400° C., or any range of any two of the above listed temperature values. Additional heating of the CO₂ is provided in Step 14 by a heater.

Following Step 14, the CO₂, which is in a supercritical state and denoted sCO₂, flows to an extraction vessel for extraction step 15. The process of extraction is Step 15 and includes loading a charge of organic material which contains the desired compounds into an extraction vessel, where the sCO₂ is used as a solvent, removing the compounds from the organic material at specified temperatures and pressures. The temperature of the continuous extraction vessel may be adjusted using band heaters or any other similar device. In the continuous extraction vessel, the sCO₂ flows over the desired compounds for extraction which causes the desired compounds to take up into the sCO₂ and carried out into the extraction vessel. The continuous extraction vessel includes features that improve both the productivity and efficiency of the process and will be discussed later.

In Step 16, the sCO₂, which is laden with compounds of interest which were taken up during the extraction of the charge material in Step 15, proceeds to at least one collection vessel. If there is more than one collection vessel, they can be denoted as Steps 16A, 16B, 16C, and so forth. Additional collection vessels may be added and are not shown in the drawings. In each collection vessel, the same or different compounds of interest “falls out” of the sCO₂ as the pressure and/or temperature is adjusted to cause the extracted materials to be collected. Each collection vessel includes electric resistance heaters, which are wrapped around the collection vessel. In the alternative, there may be electric resistance heaters contained within the chamber of each collection vessel, or may be embedded within the walls of each collection vessel.

After at least one collection step involving at least one collection vessel, the CO₂ is recycled in Step 17. In this step, the computer measures the temperature and pressure of the CO₂ to ensure that it is in the form of a gas and that most compounds have been collected in each of the collection vessels. Similar to the other steps and sections mentioned above, the computer controls the CO₂ through the use of electric resistance heaters which are contained within the chamber of each collection vessel. Following the recycling of Step 17, the now clean CO₂ returns to the chiller of Step 11 where it begins the cycle again.

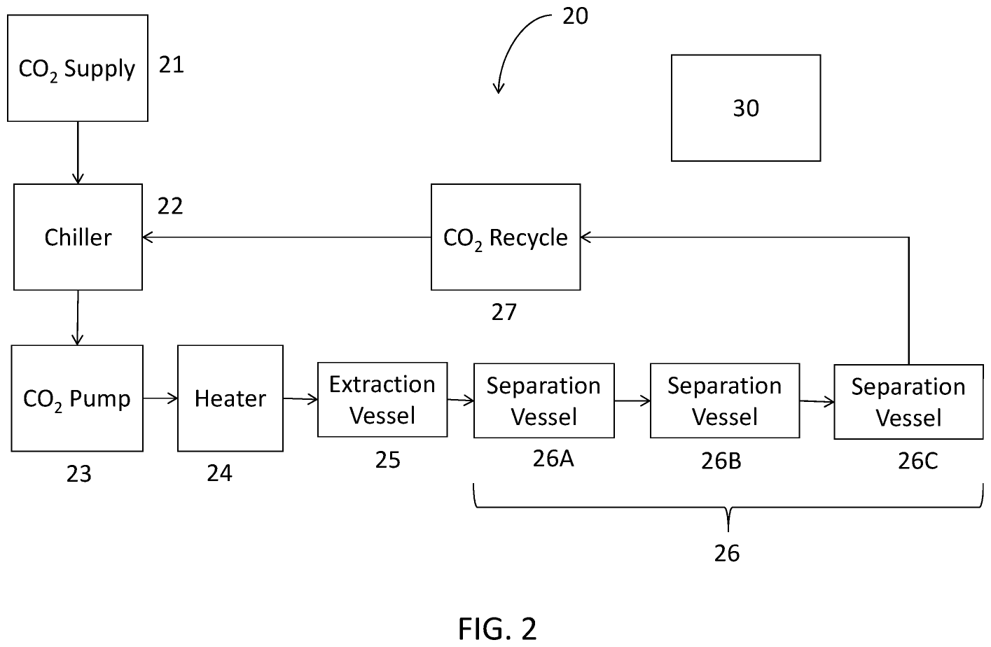

Similarly, referring now to FIG. 2, a flowchart of an extraction apparatus 20 and each of the different components is described. As above, each part of the extraction apparatus is monitored and adjusted by the digital computer 30 at frequent intervals. In CO₂ supply 21, CO₂ is provided from a supply feed which can be tank of compressed CO₂ gas. Alternatively, CO₂ supply 21 may be provided by sublimating solid CO₂, desorbing CO₂ from an adsorptive material, chemical reaction, or any other manner known in the art.

Next, chiller 22 cools the CO₂ supply and any recycled CO₂ gas from the process to a temperature that is suitable for intake into the CO₂ pump 23. The chiller can function by refrigeration, by direct heat exchange with the ambient atmosphere, by liquid cooling, or any other manner known in the art. The chiller may be controlled by the digital computer 30 so that the precise temperature of the CO₂ can be selected and controlled.

Following treatment by the chiller, the CO₂ enters the CO₂ pump 23, where it is compressed and heated by mechanical action to the temperature required to operate the extraction apparatus. At this stage (after the chiller but before the pump), a flow meter may also be employed to measure the amount of CO₂ that is being fed to the pump. The CO₂ pump 23 may be a positive displacement pump such as a piston pump, rotary lobe pump, rotary gear pump, or the like. The CO₂ pump 23 may be controlled by the digital computer 30 so that the precise pressure of the CO₂ can be selected and controlled.

After the CO₂ exits the CO₂ pump 23, it is at or close to a supercritical state. At this point, the CO₂ moves to a heater 24 where it is heated to ensure that the CO₂ is at a supercritical state. The heater may be in the form of a heat pump, an electrical resistance heater, a natural gas burner, a propane burner, or any other hydrocarbon fuel burner. The heater may be controlled by the digital computer 30 so that it maintains the CO₂ within a supercritical state, and so that the density of the sCO₂ is controlled to match the extraction profile that is set within the software.

Next, the sCO₂ enters the extraction vessel 25, which contains a charge material which has been loaded inside the extraction vessel 25 and which contains compounds of interest. As described above, the sCO₂ has its temperature and pressure precisely controlled using the digital computer 30 so that it selects only certain compounds for extraction.

After the extraction vessel, the sCO₂ is laden with extracted compounds of interest, which proceeds to one or more collection vessels 26. When multiple collection vessels are present, they can be designated as separation vessels 26A, 26B, 26C, and so forth. The collection vessels may each be used to extract different compounds of interest, or they may be used to extract increasing or decreasing levels of purity of the same compounds of interest. Within each extraction vessel, the temperature and pressure is controlled by heaters or expansion valves which causes the compounds of interest to “fall out” or condense out of the supercritical CO₂. As the sCO₂ lowers its temperature and/or pressure, it becomes closer and closer, until it finally becomes, a gas. These operations are controlled as in other parts of the extraction apparatus 20 by the digital computer 30. There can be one, two, three, or more collection vessels. There can be heaters (not shown) placed within or between the collection vessels to precisely control the temperature and pressure of each.

After the sCO₂ proceeds through the one or more separation vessels 26, 26A, 26B, 26C, and so forth, it is in the state of a heated gas. Because CO₂ is inert at most typical temperatures and pressures, it is largely pure and free of the compounds of interest, which were collected within the separation vessels 26, 26A, 26B, 26C, and so forth. However, there may still be traces of residual compounds which may need to be removed from the CO₂, both in the interest of maintaining the integrity of upstream parts such as the chiller 22 and CO₂ pump 23, and also in the interest of maintaining the quality and purity of the extracted compounds. For this, a CO₂ recycle stage 27 is included to extract any remaining compounds from the CO₂ before it is returned to the chiller 22 at the beginning of the extraction apparatus 20.

The recycle stage 27 may include both chemical and mechanical means for purifying the CO₂ gas. Chemical means include chemical reaction, absorption, or adsorption. In some embodiments, chemical absorption or adsorption may be by a sorbent such as activated carbon, zeolite, diatomaceous earth, clay, silica gel, and the like, and combinations of the above. In some embodiments, mechanical means may include fractional distillation, refrigeration, heating, vortex separation, vortex condensation, and the like, and combinations of the above. Following the recycle stage 27, the purified CO₂ gas is returned to the chiller so that it can restart its circulation through the extraction apparatus 20.

Valves, heaters, and pressure sensors may be provided during or between each part of the overall extraction apparatus. These enable the digital computer to both control and monitor the process. Each valve, heater, and pressure sensor may optionally include its own digital computer circuitry that permits it to have a degree of autonomy with respect to the digital computer that controls all of the other components.

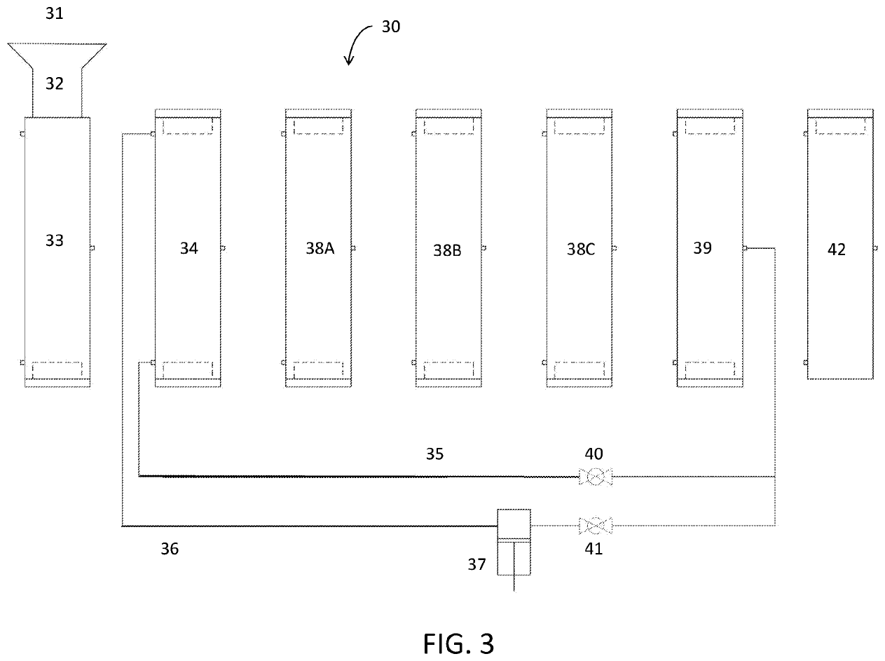

The disclosure also provides a novel continuous extraction process that minimizes the downtime and complexity that would otherwise be associated with loading, pressurizing, extracting, depressurizing, unloading, and reloading the charge of organic material. Referring now to FIG. 3, the process 30 starts with loading step 31, where the charge of organic material (not shown) is loaded into a hopper 32 which then loads the charge into an empty extraction vessel 33. During loading step 31, the empty extraction vessel is at ambient temperature and pressure, though in some embodiments, the empty extraction vessel may be maintained above ambient temperature and pressure and have at least some CO₂ inside, whether in gaseous or supercritical form. The charge is loaded by the hopper when the hopper opens the loading port of the empty extraction vessel 33 and allows the charge to drop or otherwise be moved into the empty extraction vessel 33. After the hopper completes the loading of the charge, the extraction vessel 33 is sealed by closing the loading port. In some embodiments, the hopper 32 is removed from the extraction vessel 33, though the disclosure is not so limited and in other embodiments the hopper remains attached to the extraction vessel 33.

Next, the pressurization step 34 takes place. During the pressurization step 34, bypassed CO₂ from bypass line 35 enters the now loaded extraction vessel 34. Additionally, pumped CO₂ from the pump line 36 enters the loaded extraction vessel. Pump line 36 includes a pump 37 which compresses the CO₂ to the appropriate temperature necessary for extraction. The use of the bypass line increases the efficiency of the overall operation by reusing at least some of the energy contained in the heated, pressurized CO₂, avoiding the need to repressurize and reheat that volume of CO₂.

In some embodiments, the pump compresses the CO₂ to the portion of its phase diagram beyond the critical point so that it become supercritical. The CO₂ may be pressurized up to about 7,500 psia to about 20,000 psia. In some embodiments, the pressure of the CO₂ may be about 400 psia, about 1,000 psia, about 1,500 psia, about 2,000 psia, about 2,500 psia, about 3,000 psia, about 4,000 psia, about 4,500 psia, about 5,000 psia, about 5,500 psia, about 6,000 psia, about 6,500 psia, about 7,000 psia, about 7,500 psia, about 8,000 psia, about 8,500 psia, about 9,000 psia, about 9,500 psia, about 10,000 psia, about 10,500 psia, about 11,000 psia, about 11,500 psia, about 12,000 psia, about 12,500 psia, about 13,000 psia, about 13,500 psia, about 14,000 psia, about 14,500 psia, about 15,000 psia, about 15,500 psia, about 16,000 psia, about 16,500 psia, about 17,000 psia, about 17,500 psia, about 18,000 psia, about 18,500 psia, about 19,000 psia, about 19,500 psia, about 20,000 psia, or any range of any two of the above listed pressure values. In some embodiments, the CO₂ may be heated to about 1° C. to about 250° C. and maintained at a pressure set between about 400 psi to about 20,000 psi. The temperature of the CO₂ may be about 50° C., about 100° C., about 150° C., about 200° C., about 250° C., about 300° C., about 350° C., about 400° C., or any range of any two of the above listed temperature values.

Following the pressurization step 34, extraction begins. Extraction is depicted by steps 38A, 38B, and 38C in FIG. 3, though this is not limited and there may be additional extraction steps that are not shown, or at least one extraction step may be omitted. During the extraction steps, sCO₂ is circulated through at least one extraction vessel, which acts as a solvent for the various compounds that are contained within the charge inside the at least one extraction vessel. In some embodiments, during extraction, the sCO₂ flows to at least one separation vessel (not shown in FIG. 3 but instead depicted in FIG. 1 and FIG. 2). In some embodiments, there is a separation vessel that corresponds to each extraction step, i.e., in a process with three extraction steps, there are provided three separation vessels. In some embodiments, there is instead a single separation vessel no matter how many corresponding extraction steps, and the collection vessel is sequentially emptied after the completion of each extraction step. In still other embodiments, there are two separation vessels no matter how many corresponding extraction steps are present, with one separation vessel being used with the active extraction step, and the other separation vessel being drained of compounds or otherwise prepared for switchover when the active extraction step is completed. At the switchover time, the active separation vessel becomes inactive and is drained of compounds which are collected, and the previously inactive separation vessel is brought online. This alternating process can be repeated for as many times as required based on the number of extraction steps.

At the conclusion or during each extraction step, the temperature and/or pressure of the sCO₂ is changed to cause extracted compounds to “fall out” of the sCO₂ within the separation vessel, and the extracted compounds are eventually collected. The collection is typically by gravity and utilizes a drain valve (not shown) at the bottom of the at least one separation vessel. The extracted, now collected compounds may be further processed or consumed as extracted.

In some embodiments, during at least one of the extraction steps, there is a “soak” period where sCO₂ is present within the extraction vessel but no sCO₂ is permitted to enter or leave the extraction vessel. Such processes can be useful where additional time for the solventing and/or diffusion of compounds from the charge material is necessary for extraction, but where the pumping of fresh sCO₂ does not yield appreciable solventing and/or diffusion of the compounds into the sCO₂. The soak period may be about 0 seconds (that is, there is no soak period), about 5 seconds, about 10 seconds, about 15 seconds, about 20 seconds, about 25 seconds, about 30 seconds, about 35 seconds, about 40 seconds, about 45 seconds, about 50 seconds, about 55 seconds, about 60 seconds, about 65 seconds, about 70 seconds, about 75 seconds, about 80 seconds, about 85 seconds, about 90 seconds, about 95 seconds, about 100 seconds, about 105 seconds, about 110 seconds, about 115 seconds, about 120 seconds, or any range of time that is made up of any two of the above values. In some embodiments, the soak period is a range about 15 to about 30 seconds, about 30 seconds to about 45 seconds, about 45 seconds to about 60 seconds, or about 60 seconds to about 75 seconds, or about 75 seconds to about 90 seconds.

The extraction time is not limited and is dependent on the desired grades of extracted material, the flow rates of sCO₂ and/or CO₂, pressures, temperatures, and other factors related factors. In some embodiments, the extraction time is about 15 seconds, about 30 seconds, about 45 seconds, about 60 seconds, about 75 seconds, about 90 seconds, about 105 seconds, about 120 seconds, about 135 seconds, about 150 seconds, about 165 seconds, about 180 seconds, about 195 seconds, about 210 seconds, about 225 seconds, about 240 seconds, about 255 seconds, about 270 seconds, about 285 seconds, about 300 seconds, about 315 seconds, about 330 seconds, about 345 seconds, about 360 seconds, about 375 seconds, about 390 seconds, about 405 seconds, about 420 seconds, or any range of time that is made up of the above values as endpoints. Furthermore, in some embodiments, the above extraction times are exclusive of the soak period (i.e., the extraction time does not include the soak period). In still other embodiments, the above extraction times are inclusive of the soak period (i.e., the extraction time includes the time spend on a soak period step).

Following the extraction steps 38A, 38B, 38C, and so forth, the extraction vessel is depressurized in depressurization step 39 by opening at least one valve (not shown) to allow the sCO₂ and/or CO₂ to exit the extraction vessel. The released sCO₂ and/or CO₂ is then recycled as described above, bypassed through the initial depressure line 35, or is sent to pump 37 where pressure and/or heat are added. One or more of the above options for the released sCO₂ and/or CO₂ may be used alone or in combination. The temperature, pressure, or flow rate may be controlled using valves 40 and 41 which are included on the initial depressure line 35 and the final depressure line 36.

Following the depressurization step 39, the extraction vessel may be opened by removing a cover from a port or otherwise opening a large valve or other similar device as shown by the graphic of the empty extraction vessel 42 in FIG. 3. With the extraction vessel open, the now spent charge material can be removed, either by hand, by dropping out of the bottom of the extraction vessel. The port, opening, valve, etc. is ideally designed for rapid opening and closing and should also be able to withstand the high pressures required during the extraction process. The port or opening on the extraction vessel may use a clamp, tapered thread, external thread, internal thread, or combinations of the above. In some embodiments, the port or opening includes an interrupted thread or stepped interrupted thread structure that permits the port or opening to be rapidly and securely opened and closed. The interrupted thread or stepped interrupted thread may further include sealing components such as O-rings or related ubturating rings or other ubturating structures which fit within the breech or cavity of the extraction vessel to form a tight seal.

In some embodiments, during depressurization step 39, the sCO₂ and/or CO₂ bypasses the pump and is routed through bypass line 35 and associated valve 40. When this occurs, sCO₂ and/or CO₂ flows from the depressurized extraction vessel 39 into the waiting extraction vessel that is undergoing pressurization in step 34. When the bypassed sCO₂ and/or CO₂ is not sufficient to bring the extraction vessel up to full pressure and temperature needed for the extraction depicted in steps 38A, 38B, 38C, and so forth, it can be supplemented by heat and pressure provided by pump 37. In some embodiments, the heat and pressure provided by pump 37 is provided at the same time that the bypassed sCO₂ and/or CO₂ are permitted to move from the extraction vessel in depressurization step 39 to the extraction vessel in pressurization step 34. However, in other embodiments, the pump remains inactive and the valve 41 remains closed first while the sCO₂ and/or CO₂ flows through the bypass line 35 and associated valve 40. Only once the pressure between an extraction vessel that is undergoing the pressurization step 34 and the pressurization that is undergoing the pressurization step 39 are approximately equal to each other or actually equal to each other, is the valve 40 closed and valve 41 opened. Once valve 41 is opened, the pump 37 is activated so that the remaining sCO₂ and/or CO₂ is pumped and heated into the extraction vessel in pressurization step 34. In addition to the sCO₂ and/or CO₂ that is transferred using the pump 37 in FIG. 3, additional CO₂ may be added as conditions necessary by way of additional CO₂ supply, such as depicted in FIGS. 1 and 2.

In the above embodiments, heat may be supplied to influence the state of the sCO₂ and/or CO₂. In some embodiments, the collection vessel and/or extraction vessel include electric resistance heaters which are wrapped around the collection vessel and/or extraction vessel. In other embodiments, the electric resistance heaters are embedded within the walls of each collection vessel. The electric resistance heaters may be controlled by the digital computer to precisely control the temperature in each extraction vessel and each collection vessel, thereby enabling a human operator to select exact compounds for collection in each of the collection vessels.

Valves, heaters, and pressure sensors may be provided during or between each step. These enable the digital computer to both control and monitor the process. Each valve, heater, and pressure sensor may optionally include its own digital computer circuitry that permits it to have a degree of autonomy with respect to the digital computer that controls all of the other components.

The design of the hopper 32 is not limited and can be any design that permits the fast, safe, and effective loading of the charge material during loading step 31 into the extraction vessel 33 as depicted in FIG. 3. Because the charge material is typically in the form of loose plant matter, the hopper design should be resistant to problems such as “ratholing” or “piping” where only the core of the hopper discharges but the stable side portions remain in place without flowing, slow flow, “arching” or “doming” where the charge material forms cohesive bridges or domes that hold it in place and stop the flow, material segregation, and packing or settling materials that prevent discharge. The hopper may utilize principles of mass flow, funnel flow, or the combination mass flow and funnel flow which is known as expanded flow.

In some embodiments, the hopper 32 uses internal structures to assist in moving the charge material from the hopper to the extraction vessel. Such structures include material vibrators, material mixers, and the like. In still other embodiments, the hopper itself may be coupled to a vibrator which assists in moving the charge material from the hopper to the extraction vessel. In some embodiments, the hopper includes devices for precisely metering the amount of charge material into the extraction vessel 33. The metering may be by any method, including by weight or by volume, for instance by measuring the displacement or intake of a fluid as the charge material is loaded and/or discharged from the hopper.

In some embodiments, the hopper 32 is integrated or connected to the extraction vessel as a single device. In such embodiments, the hopper cannot be removed except for service during stoppage of production, and the hopper is also integrated with the door or other apparatus that seals the extraction vessel 33 in step 31. In other embodiments, the hopper is a separate, movable device that during operation can be quickly moved away from the extraction vessel 33. Such embodiments are useful if the apparatus includes more than one extraction vessel that is to be loaded with charge material but duplication of the hopper 32 is not desired or required.

In some embodiments, the hopper is sized to hold the amount of charge material necessary for one “run” or iteration of extraction. In other embodiments, the hoppers is sized to hold the amount of charge material necessary for about 2 iterations, about 3 iterations, about 4 iterations, about 5 iterations, about 6 iterations, about 7 iterations, about 9 iterations, or about 10 iterations of extraction, or any range made up of the above amounts as endpoints. In some embodiments, the hopper has a volume of about 1 liter, about 2 liter, about 3 liter, about 4 liter, about 5 liter, about 6 liter, about 7 liter, about 8 liter, about 9 liter, about 10 liter, about 11 liter about 12 liter, about 13 liter, about 14 liter, about 15 liter, about 16 liter, about 17 liter, about 18 liter, about 19 liter, or about 20 liter, or any range made up of the above amounts as endpoints. In some embodiments, the hopper has a volume of less than about 5 liter, about 5 liter to about 10 liter, about 10 liter to about 15 liter, about 15 liter to about 20 liter, about 20 liter to about 25 liter, about 30 liter to about 35 liter, about 35 liter to about 40 liter, or any range formed by the combination of two or more of the above ranges.

### Extraction Vessel

The extraction vessel may be of any required shape and size, but it is typically in the form of a cylinder to maximize the efficiency of the flow of sCO₂ and/or CO₂. In some embodiments, the extraction vessel has an internal volume of about 0.1 liter, about 0.2 liter, about 0.3 liter, about 0.4 liter, about 0.5 liter, about 0.6 liter, about 0.7 liter, about 0.8 liter, about 0.9 liter, about 1.0 liter, about 1.1 liter, about 1.2 liter, about 1.3 liter, about 1.4 liter, about 1.5 liter, about 1.6 liter, about 1.7 liter, about 1.8 liter, about 1.9 liter, about 2.0 liter, about 3.0 liter, about 4.0 liter, about 5.0 liter, and any range that is made of the combination of the above volumes. In some embodiments, the internal volume of the extraction vessel is less than about 2.0 liter, less than about 1.5 liter, less than about 1.0 liter, less than about 0.7 liter, less than about 0.5 liter, less than about 0.4 liter, less than about 0.3 liter, less than about 0.2 liter, or less than about 0.1 liter.

In some embodiments, the extraction apparatus include a single extraction vessel. However, in some embodiments, the extraction apparatus may include multiple extraction vessels that can be used in conjunction with each other to improve the efficiency of loading charge material, improve production throughput, provide for blending multiple different charge materials of different grades, varieties, etc. of organic material. In some embodiments, there is one extraction vessel, two extraction vessels, three extraction vessels, four extraction vessels, or five extraction vessels. It should be noted that the number of extraction vessels is not limited and that the overall extraction apparatus is designed to incorporate any number of extraction vessels that is at least one depending on the require production throughput, among other considerations.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of continuous extraction of compounds from a charge material, comprising:
loading a charge material from a hopper into an extraction vessel through a loading port;
closing the loading port;
pressurizing the extraction vessel with sCO₂ and/or CO₂ from a bypass line;
extracting compounds from the charge material; and
depressurizing the extraction vessel by sending sCO₂ and/or CO₂ through the bypass line.

2. The method of claim 1, wherein the extraction vessel has an internal volume of less than about 2.0 liters.

3. The method of claim 2, wherein the extraction vessel has an internal volume of less than about 1.0 liter.

4. The method of claim 1, wherein the compounds extracted from the charge material are selected from the group consisting of cannabinoids, tetrahydrocannabinol (THC), cannabinoid isomers, cannabinoid stereoisomers, tetrahydrocannabinolic acid (THCA), cannabidiol (CBD), cannabidiolic acid (CBDA), cannabinol, (CBN), cannabigerol (CBG), cannabichromene (CPC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannebielsoin (CBE), cannabicitran (CBT), and combinations and derivatives thereof.

5. The method of claim 1, wherein the charge material is cannabis.

6. The method of claim 1, wherein the steps of loading the charge materials, pressurizing the extraction vessel, extracting the compounds from the charge materials, and depressurizing the extraction vessel are performed in sequential order.

7. An apparatus for continuous extraction of compounds from a charge material, comprising:
a hopper for loading a charge material from the hopper into an extraction vessel through a loading port, wherein the loading port can be closed;
a bypass line for pressurizing the extraction vessel with sCO₂ and/or CO₂;
wherein during operation the extraction vessel extracts compounds from the charge material; and
wherein during operation the extraction vessel is depressurized by sending sCO₂ and/or CO₂ through the bypass line.

8. The apparatus of claim 7, wherein the extraction vessel has an internal volume of less than about 2.0 liters.

9. The apparatus of claim 8, wherein the extraction vessel has an internal volume of less than about 1.0 liter.

10. The apparatus of claim 7, wherein the compounds that the apparatus extracts from the charge material are selected from the group consisting of cannabinoids, tetrahydrocannabinol (THC), cannabinoid isomers, cannabinoid stereoisomers, tetrahydrocannabinolic acid (THCA), cannabidiol (CBD), cannabidiolic acid (CBDA), cannabinol, (CBN), cannabigerol (CBG), cannabichromene (CPC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannebielsoin (CBE), cannabicitran (CBT), and combinations and derivatives thereof.

11. The apparatus of claim 7, wherein the charge material is cannabis.

12. The apparatus of claim 7, wherein the apparatus loads the charge materials, pressurizes the extraction vessel, extracts the compounds from the charge materials, and depressurizes the extraction vessel in sequential order.
